(19) United States
(12) Patent Application Publication
(10) Pub. No.: US 2026/0018082 A1
(43) Pub. Date: Jan. 15, 2026

(54) SYSTEMS AND METHODS FOR TEACHING MUSIC NOTATION COMPREHENSION

(71) Applicant: Kennesaw State University Research And Service Foundation, Inc., Kennesaw, GA (US)

(72) Inventors: Erin Collins, Marietta, GA (US); Tiffany Roman, Marietta, GA (US)

(21) Appl. No.: 19/265,779

(22) Filed: Jul. 10, 2025

Related U.S. Application Data
(60) Provisional application No. 63/669,832, filed on Jul. 11, 2024.

(51) Int. Cl. G09B 15/02; G09B 5/02

(52) U.S. Cl. CPC G09B 15/023; G09B 5/02

(57) ABSTRACT

A computing device may receive, via an interface of the computing device, a selection of music. In addition, the computing device may generate a first representation of the music, wherein the first representation may include symbols, and wherein the first representation of the music does not include clef, staff, or notes. The computing device may generate a second representation of the music, wherein the second representation of the music may include the symbols overlayed on notes. The computing device may generate a third representation of the music, where the third representation of the music may include the symbols overlayed on the notes and clef and staff. The computing device may generate a fourth representation of the music, where the fourth representation of the music may include the notes, clef, and staff, and where the fourth representation of the music does not include the symbols.

### CROSS-REFERENCE TO RELATED APPLICATIONS

This application is nonprovisional of provisional Patent Application No. 63/669,832, filed Jul. 11, 2024, which is hereby incorporated by reference in its entirety for any and all purposes.

### BACKGROUND

The demands on educators are increasing. In some cases, classrooms are overpopulated with students and understaffed with teachers. Often, subjects, such as music, that are not evaluated on standardized tests can be deprioritized. Students may be left to pick up these subjects on their own.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include receiving, via an interface of a computing device, a selection of music. The method may also include presenting, via the interface, a first representation of the music, where the first representation may include symbols, where each symbol corresponds to an aspect of the music, where the aspect of the music is at least one of pitch and duration, and where the first representation of the music does not include clef, staff, or notes. The method may furthermore include receiving, via the interface, an indication of readiness to transition to a second representation of the music. The method may in addition include presenting, via the interface, the second representation of the music, where the second representation of the music may include the symbols overlayed on notes, and where the second representation of the music does not include clef or staff. The method may moreover include receiving, via the interface, an indication of readiness to transition to a third representation of the music. The method may also include presenting, via the interface, the third representation of the music, where the third representation of the music may include the symbols overlayed on the notes and clef and staff. The method may furthermore include receiving, via the interface, an indication of readiness to transition to a fourth representation of the music. The method may in addition include presenting, via the interface, the fourth representation of the music, where the fourth representation of the music may include the notes, clef, and staff, and where the fourth representation of the music does not include the symbols. Other embodiments of this aspect include corresponding computer systems, apparatus, and computer programs recorded on one or more computer storage devices, each configured to perform the actions of the methods.

Implementations may include one or more of the following features. The method where each symbol corresponds to a component of an instrument configured to produce a pitch. The method where each symbol corresponds to a key on a keyboard or a tonal bar. The method where each symbol indicating a particular pitch may include a particular color or pattern and a corresponding key or tonal bar is associated with the particular pitch and may include the particular color or pattern. The method where one or more of a color, pattern, and vertical position of a particular symbol of the symbols indicates a pitch indicated by the particular symbol. The method where a size of a particular symbol of the symbols indicates a duration indicated by the particular symbol. The method where the staff is a pentagram. The method where the fourth representation of the music is a Western Standard Notation representation of the music. The method may include: receiving, via the interface, an indication of readiness to transition to the third representation of the music; presenting, via the interface, the third representation of the music. The method may include: receiving, via the interface, an indication of readiness to transition to the second representation of the music; presenting, via the interface, the second representation of the music. The method may include: receiving, via the interface, an indication of readiness to transition to the first representation of the music; presenting, via the interface, the first representation of the music. Implementations of the described techniques may include hardware, a method or process, or a computer tangible medium.

In one general aspect, a system may include a musical instrument having components configured to produce a pitch, where at least two of the components of the musical instrument may include an attribute, and where each attribute indicates a pitch associated with the component. The system may also include a computing device configured to: receive, via an interface, a selection of music; present, via the interface, a first representation of the music, where the first representation may include symbols, where each symbol corresponds to an aspect of the music, where the aspect of the music is at least one of pitch and duration, and where the first representation of the music does not include clef, staff, or notes; receive, via the interface, an indication of readiness to transition to a second representation of the music; present, via the interface, the second representation of the music, where the second representation of the music may include the symbols overlayed on notes, and where the second representation of the music does not include clef or staff; receive, via the interface, an indication of readiness to transition to a third representation of the music; present, via the interface, the third representation of the music, where the third representation of the music may include the symbols overlayed on the notes and clef and staff; receive, via the interface, an indication of readiness to transition to a fourth representation of the music; and present, via the interface, the fourth representation of the music, where the fourth representation of the music may include the notes, clef, and staff, and where the fourth representation of the music does not include the symbols. Other embodiments of this aspect include corresponding computer systems, apparatus, and computer programs recorded on one or more computer storage devices, each configured to perform the actions of the methods.

Implementations may include one or more of the following features. The system where the musical instrument is an instrument with a keyboard or tonal bars and the at least two components are at least two keys of the keyboard or tonal bars. The system where the attribute may include a color or pattern. The system where a vertical position of a particular symbol of the symbols indicates a pitch of the particular symbol. The system where a size of a particular symbol of the symbols indicates a duration a corresponding component of the musical instrument indicated by the particular symbol should be engaged. The system where the staff is a pentagram. The system where the fourth representation of the music is a Western Standard Notation representation of the music. The system where the computing device is further configured to: receive, via the interface, an indication of readiness to transition to the third representation of the music; present, via the interface, the third representation of the music. The system where the computing device is further configured to: receive, via the interface, an indication of readiness to transition to the second representation of the music; present, via the interface, the second representation of the music. The system where the computing device is further configured to: receive, via the interface, an indication of readiness to transition to the first representation of the music; present, via the interface, the first representation of the music. The system where the musical instrument is a virtual musical instrument on a computing device. The system where the components of the musical instrument are virtual keys of a virtual keyboard displayed on a touch screen. The system where the components of the musical instrument are virtual tonal bars of a virtual xylophone displayed on a touch screen. Implementations of the described techniques may include hardware, a method or process, or a computer tangible medium.

In one general aspect, a method may include receiving, via an interface of a computing device, a selection of music. The method may also include generating a first representation of the music, where the first representation may include symbols, where each symbol corresponds to an aspect of the music, where the aspect of the music is at least one of pitch and duration, and where the first representation of the music does not include clef, staff, or notes. The method may furthermore include generating a second representation of the music, where the second representation of the music may include the symbols overlayed on notes, and where the second representation of the music does not include clef or staff. The method may in addition include generating a third representation of the music, where the third representation of the music may include the symbols overlayed on the notes and clef and staff. The method may moreover include generating a fourth representation of the music, where the fourth representation of the music may include the notes, clef, and staff, and where the fourth representation of the music does not include the symbols. Other embodiments of this aspect include corresponding computer systems, apparatus, and computer programs recorded on one or more computer storage devices, each configured to perform the actions of the methods.

Implementations may include one or more of the following features. The method may include: determining a determined representation of the music of the first representation of the music, the second representation of the music, the third representation of the music, and the fourth representation of the music; and presenting, via the interface, the determined representation of the music. Implementations of the described techniques may include hardware, a method or process, or a computer tangible medium.

In one general aspect, a computing device may include one or more processors configured to perform the method of any of claims 1-11. Other embodiments of this aspect include corresponding computer systems, apparatus, and computer programs recorded on one or more computer storage devices, each configured to perform the actions of the methods.

In one general aspect, a computing device may include one or more processors configured to perform the method of any of claims 25-27. Other embodiments of this aspect include corresponding computer systems, apparatus, and computer programs recorded on one or more computer storage devices, each configured to perform the actions of the methods.

In one general aspect, a computing device may include one or more processors configured to: receive, via an interface of a computing device, a selection of music; present, via the interface, a first representation of the music, where the first representation may include symbols, where each symbol corresponds to an aspect of the music, where the aspect of the music is at least one of pitch and duration, and where the first representation of the music does not include clef, staff, or notes; receive, via the interface, an indication of readiness to transition to a second representation of the music; present, via the interface, the second representation of the music, where the second representation of the music may include the symbols overlayed on notes, and where the second representation of the music does not include clef or staff; receive, via the interface, an indication of readiness to transition to a third representation of the music; present, via the interface, the third representation of the music, where the third representation of the music may include the symbols overlayed on the notes and clef and staff; receive, via the interface, an indication of readiness to transition to a fourth representation of the music; and present, via the interface, the fourth representation of the music, where the fourth representation of the music may include the notes, clef, and staff, and where the fourth representation of the music does not include the symbols. Other embodiments of this aspect include corresponding computer systems, apparatus, and computer programs recorded on one or more computer storage devices, each configured to perform the actions of the methods.

Implementations may include one or more of the following features. The computing device where each symbol corresponds to a component of an instrument configured to produce a pitch. The computing device where each symbol corresponds to a key on a keyboard or a tonal bar. The computing device where the one or more processors, when each symbol indicating a particular pitch, are configured to a particular color or pattern and a corresponding key or tonal bar is associated with the particular pitch and may include. The computing device where one or more of a color, pattern, and vertical position of a particular symbol of the symbols indicates a pitch indicated by the particular symbol. The computing device where a size of a particular symbol of the symbols indicates a duration indicated by the particular symbol. The computing device where the staff is a pentagram. The computing device where the fourth representation of the music is a Western Standard Notation representation of the music. The computing device where the one or more processors are further configured to: receive, via the interface, an indication of readiness to transition to the third representation of the music; and present, via the interface, the third representation of the music. The computing device where the one or more processors are further configured to: receive, via the interface, an indication of readiness to transition to the second representation of the music; and present, via the interface, the second representation of the music. The computing device where the one or more processors are further configured to: receive, via the interface, an indication of readiness to transition to the first representation of the music; and present, via the interface, the first representation of the music. Implementations of the described techniques may include hardware, a method or process, or a computer tangible medium.

In one general aspect, a computing device may include one or more processors configured to: receive, via an interface of a computing device, a selection of music; generate a first representation of the music, where the first representation may include symbols, where each symbol corresponds to an aspect of the music, where the aspect of the music is at least one of pitch and duration, and where the first representation of the music does not include clef, staff, or notes; generate a second representation of the music, where the second representation of the music may include the symbols overlayed on notes, and where the second representation of the music does not include clef or staff; generate a third representation of the music, where the third representation of the music may include the symbols overlayed on the notes and clef and staff; and generate a fourth representation of the music, where the fourth representation of the music may include the notes, clef, and staff, and where the fourth representation of the music does not include the symbols. Other embodiments of this aspect include corresponding computer systems, apparatus, and computer programs recorded on one or more computer storage devices, each configured to perform the actions of the methods.

Implementations may include one or more of the following features. The computing device where the one or more processors are further configured to: determine a determined representation of the music of the first representation of the music, the second representation of the music, the third representation of the music, and the fourth representation of the music; and present, via the interface, the determined representation of the music. Implementations of the described techniques may include hardware, a method or process, or a computer tangible medium.

In one general aspect, a kit may include a plurality of stickers, where each sticker may include a symbol indicating an aspect of music, where each sticker is configured to be coupled to a component of a musical instrument, and where a component of the musical instrument that a sticker is coupled to is associated with the aspect of music indicated by the symbol associated with the sticker. The kit may also include a plurality of sheets having representations of music, where a first sheet may include a first representation of the music having symbols associated with the plurality of stickers, where a second sheet may include a second representation of the music having the symbols overlayed on associated notes, where a third sheet may include a third representation of the music having the symbols overlayed on associated notes, clef, and staff, and where a fourth sheet may include a fourth representation of the music, where the fourth representation of the music may include the notes, clef, and staff, and where the fourth representation of the music does not include the symbols.

Implementations may include one or more of the following features. The kit where each of the plurality of stickers is configured to be coupled with a key of a keyboard. The kit where each of the plurality of stickers is configured to be coupled to an area of a recorder proximate to a hole. The kit where each of the plurality of stickers is configured to be coupled with a key of a musical instrument. The kit where each of the plurality of stickers is configured to be coupled to an area of a musical instrument proximate to a hole. The kit where each of the plurality of stickers is configured to be coupled to a tonal bar of a xylophone. The kit where each of the plurality of stickers is configured to be coupled to a tonal bar of a musical instrument.

Some aspects of the systems and/or methods described herein may be embodied in an application in accordance with the present disclosure. The application may be a web application. For example, the application may be at least partially coded in PHP, Python, or any other programming language. The application may have one or more access code fields to prevent unauthorized use. The application may comprise metadata fields to facilitate tagging for search and/or classification of songs and/or work sheets. The application may comprise user accounts, logins, facilitate subscription billing, etc.

Traditional methods of teaching young learners how to read music rely on skill and drill practice for note recognition and do not alleviate the cognitive and visual burdens. The present disclosure allows educators or learners to choose the level of support needed to read and play more efficiently with the goal of transitioning to traditional notation. The present disclosure offers a paper version, including all levels of support, for use with instruments and is in current development of a digital application version for online access to songs with the same adjustable levels of support.

The process of transitioning from reading music with scaffolded support to traditional notation with the aim of alleviating cognitive burden is something not seen in other products. The supports present in the create function and gradual transition to standard notation is also not seen in other products.

### BRIEF DESCRIPTION OF THE DRAWINGS

FIG. 1 shows an example first representation of a first portion of music.

FIG. 2 shows an example second representation of the first portion of music.

FIG. 3 shows an example third representation of the first portion of music.

FIG. 4 shows an example fourth representation of the first portion of music.

FIG. 5 shows an example of music in Western Standard Music Notation.

FIG. 6 shows an example interface with a representation of a portion of music with symbols overlayed on notes and staff and clef.

FIG. 7 shows an example interface with a representation of a portion of music with symbols, but no notes, staff, or clef.

FIG. 8 shows an example of symbols overlayed on notes in a horizontal line juxtaposed with an example of symbols overlayed on notes arranged vertically according to pitch.

FIG. 9 shows example sheet music wherein notes are overlayed with symbols.

FIG. 10 shows an example interface with a representation of a second portion of music with symbols overlayed on notes and staff and clef.

FIG. 11 shows an example interface with a representation of the second portion of music with notes and staff and clef, but no symbols overlayed on the notes.

FIG. 12 shows an example of a student using sheet music with notes and staff and clef and color-coded symbols overlayed on the notes, and an application with virtual keyboard with color-coded keys.

FIG. 13 shows an example of students using hand lettered song sheets, and an electric keyboard with letter labeled keys.

FIG. 14 shows example color-coded instruments.

FIG. 15 shows an example of a representation of a portion of music with symbols overlayed on notes and staff and clef.

FIG. 16 shows an example of students with a representation of a portion of music with color circles and color-coded piano keys.

FIG. 17 shows example prior art showing color notes.

FIG. 18 shows example prior art showing color notes with a five-line staff and clef.

FIG. 19 shows an example of a representation of a portion of music with symbols overlayed on notes and staff and clef.

FIGS. 20A-20B show an example flowchart of a process for teaching music notation.

FIG. 21 shows an example flowchart of a process for teaching music notation.

FIG. 22 shows an example representation of music with color-coded symbols.

FIG. 23 shows an example keyboard with color-coded keys.

FIG. 24 shows an example representation of music with color-coded symbols overlayed traditional notation.

FIG. 25 shows an example representation of music with traditional notation.

FIG. 26 shows an example system with sketched color melodies.

FIG. 27 shows an example representation of music with color-coded symbols.

FIG. 28 shows an example representation of music with color-coded symbols overlayed notes.

FIG. 29 shows an example representation of music with color-coded symbols overlayed traditional notation.

FIG. 30 shows an example representation of music in traditional notation.

FIG. 31 shows an example display of music representation according to the systems and methods described herein.

FIG. 32 shows an example display of music representation according to the systems and methods described herein.

FIG. 33 shows an example graphical user interface according to the systems and methods described herein.

FIG. 34 shows an example color coded instruments and an associated music representation with the correct associated coloring.

### DETAILED DESCRIPTION

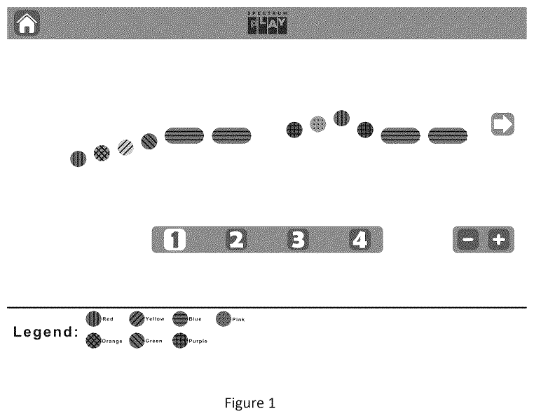

FIG. 1 shows an example first representation of a first portion of music. The first representation of the first portion of the music may comprise symbols. The symbols may comprise attributes. The attributes may comprise a color, a pattern, a vertical position, etc. The attributes may indicate a pitch. The symbols may comprise a horizontal width indicative of a duration. The symbols may follow an up and down motion of a melodic line. The first representation of the first portion of the music may be displayed in a first screen of a user interface. The first screen may comprise one or more elements that allow a user to transition to a different representation of the first portion of the music. The first screen may comprise one or more elements to transition to a different portion of the music. The first screen may comprise one or more elements to allow a user to zoom in and/or out. The first representation of the first portion of the music does not have notes, a staff, or a clef.

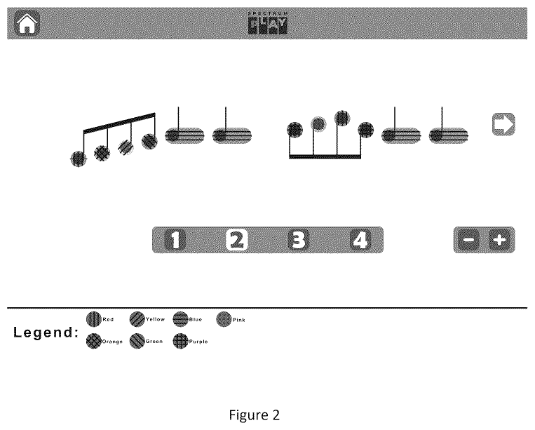

FIG. 2 shows an example second representation of the first portion of the music. The second representation of the first portion of the music may comprise notes. The second representation of the first portion of the music may comprise the symbols overlayed on the notes. The second representation of the first portion of the music may be displayed in a second screen of the user interface. The second screen may be similar to the first screen. The second representation of the first portion of the music does not have a staff or a clef.

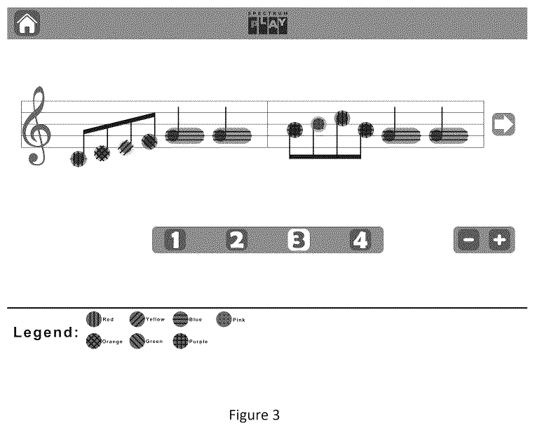

FIG. 3 shows an example third representation of the first portion of the music. The third representation of the first portion of the music may comprise notes positioned on a staff and a clef. The third representation of the first portion of the music may comprise the symbols overlayed on the notes. The third representation of the first portion of the music may be displayed in a third screen of the user interface. The third screen may be similar to the first screen and/or second screen.

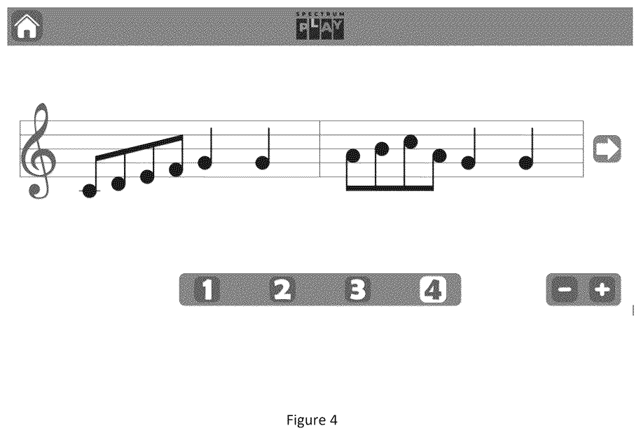

FIG. 4 shows an example fourth representation of the first portion of the music. The fourth representation of the first portion of the music may comprise notes positioned on a staff and a clef. The fourth representation of the first portion of the music may be displayed in a fourth screen of the user interface. The fourth screen may be similar to the first screen, second screen, and/or third screen. The fourth representation of the first portion of the music does not have the symbols.

The present disclosure may comprise a digital tool created to support learning and instruction of elementary music literacy and composition in inclusive classrooms. The learning supports embedded in the tool enable students with visual processing difficulties learn to read music notation and play independently. Informed by Universal Design for Learning and Cognitive Load Theory, the present disclosure emerged as a direct response to the needs of diverse students. The tool evolved from a paper prototype that supported independent learning to a digital software that accounts for individual learner needs. As described herein, design judgments and prototype iterations provide precedent to the learning technologies design community for transforming an inclusive instructional design strategy into a digital tool with broad transformational reach.

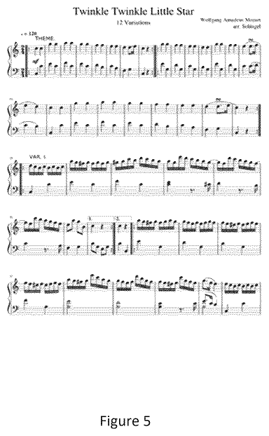

The present disclosure may comprise a digital tool intended to support learning and instruction of music literacy and composition for elementary students in the music classroom. Many young learners struggle with the complex process of learning to read Western Standard Music Notation (i.e., how music is typically visually presented, see FIG. 5), particularly students with special needs (Jaarsma & Ruijssenaars, 1998, p. 152). The Western Standard Music Notation requires a large learning curve demanding significant cognitive load (Kuo & Chuang, 2013). Using Western Standard Notation requires symbolic decoding skills where written symbols are translated into various musical characteristics to be played (Kivijärvi & Väkevä, 2020). In more simplistic terms, learning to read music can be quite hard, particularly at the onset as it requires learners to chunk information, use their motor cognitive skills, and self-monitor their performance while also building on their existing music knowledge (Sloboda, 1985, as cited by Owens & Sweller, 2008).

The present disclosure provides scaffolded notation using colors and arrangements of songs for melodic instruments (e.g., piano, xylophone). A simplified arrangement allows students to quickly transition from learning to read music to playing on their own. The overarching goal of the technology is to remove barriers and increase access to music for all learners. Students can choose the level of visual support they need with the option to gradually move towards standard notation.

The present disclosure details how this innovative intervention leverages digital and non-digital technologies to transform teaching and learning in the K-5 music classroom. Described herein are the theories that informed the design and how the present disclosure is used in practice by teachers and students in K-5 music classrooms. Additionally, described herein is the inspiration for the design, detail the design context, speak to the complexity of the issues related to the design, acknowledge design failures, and articulate the case relevance and interest to the broader instructional design and technology community.

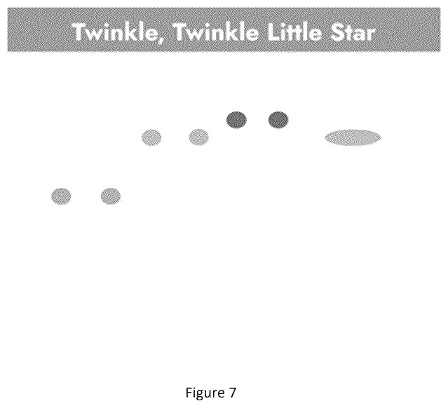

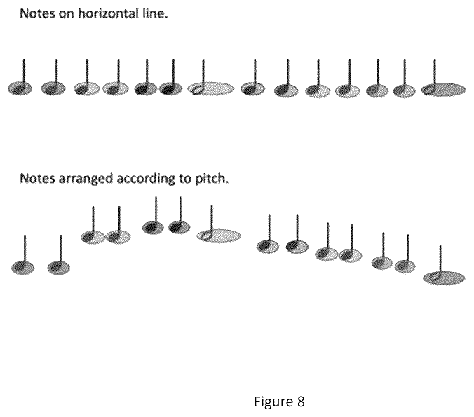

The present disclosure also was informed by limitations of existing software which do not address the critical skill of playing music and instead focuses on a skill and drill approach. Since the present disclosure may combine elements of color-coding notation with scaffolding of the learning process, all students can progress at their own pace. While the objective of skill drill games is note identification, the present disclosure may go beyond identifying notes to mastering music literacy, which is foundational to playing a musical instrument. This unique perspective to the present disclosure is reflected in the spatial representation of music notations on invisible melodic lines (see FIG. 7). Rather than situating all notes on a single horizontal line (see FIG. 8), an approach taken by researchers Kuo and Chuong (2013), this spatially integrated design judgment assists students in decreasing their cognitive load by supporting “cross-source integration of mutually referring elements” (Sweller, 2008, p. 42). In other words, by eliminating lines of a music staff while still providing students with a spatial reference of the music arrangement, two elements are visible while reducing cognitive load. As students progress in their ability to play music, lines from the music staff are added back in to support students' skills and knowledge in identifying notes in Western Standard Notation. This directly aligns with the UDL principle of multiple means of representation, specifically for language and symbols by helping learners decode musical notation.

### Representation of the Design

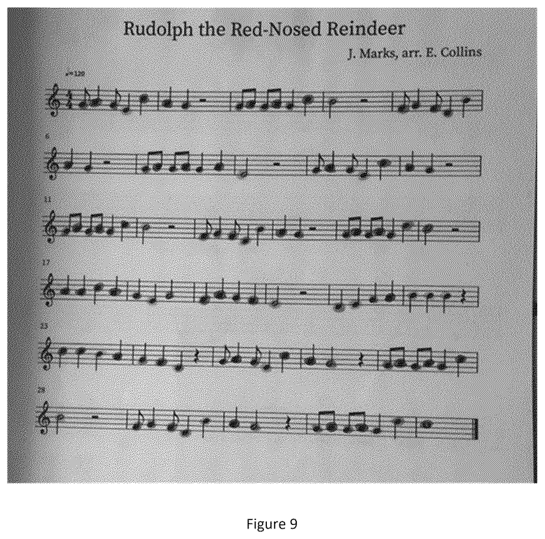

Although one of skill may have access to color-coded notation and instruments from Boomwhackers (Rhythm Band Instruments, 2024), which uses different lengths of color-coded plastic tubes matched to a C major scale, the color-coded notation proved difficult for students to read due to spacing and contrast issues. For example, yellow did not provide enough contrast, nor did half notes or whole note icons in any color, which have circular noteheads that are hollow. To address an immediate need, the teacher hand-colored print copies of sheet music (see FIG. 9) to enable her students to play independently. Prior research has supported that color-coded notations can be easier to play than standard notions (Rogers, 1991). To address an immediate need for a better design solution, the teacher hand-colored print copies of sheet music (see FIG. 9) to enable her students to play independently.

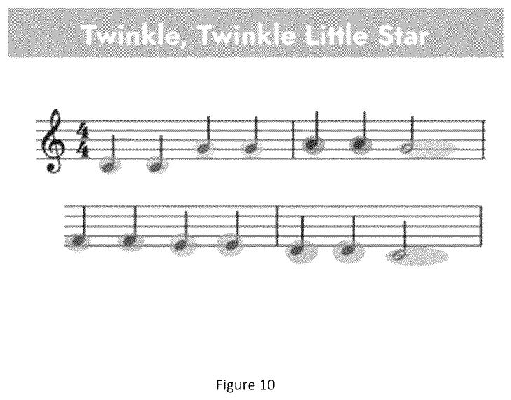

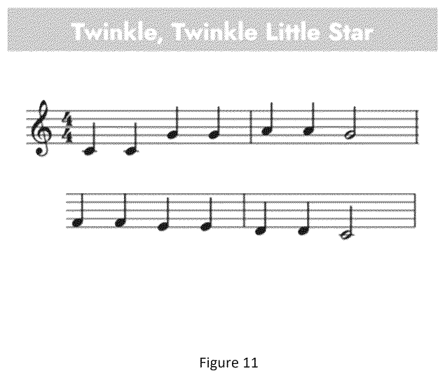

Translating the paper-based version of the present systems, kits, and methods into a digital interface required considering reducing complexity in the design. The preliminary digital interface offered songs in three different presentations according to levels of cognitive processing demand. Level one (see FIG. 7) had the lowest cognitive load with the simplest presentation of colored circles representing the notes of the C major scale corresponding with the colors of the visible light spectrum (e.g., red, orange, yellow, green, blue, indigo, violet). Level two (see FIG. 10) presented the song with same color circles as an overlay atop the song standard notation. The color overlays let the learner easily match the note color to the corresponding color on their instrument. Level three (see FIG. 11) presented the song in standard notation without color supports. Although there is an existing software on the market that uses color-coded notation to support children with development delays to play music, called FigureNotes (Drake Music Scotland, 2022), the teacher determined for her own classroom use that the complexity of the software interface would add unnecessary cognitive processing demands on her learners so it was not an appropriate fit for her unique setting.

### Design Team

The initial design team consists of three teacher scholars. The design lead is an elementary music teacher and doctoral student who has 20 years of classroom teaching experience in music and special education. The design lead has a Bachelor of Music in Music Education, a Master of Education in Secondary Education, an Educational Specialist in Instructional Technology, and is earning her doctorate in Instructional Technology. She is certified in music, special education, and has a reading endorsement. Her research interests include Universal Design for Learning and technology use in the music classroom. Assisting the design lead as a collaborator and mentor is an Associate Professor of Instructional Technology and Innovation at a large public university in the Southeast. The faculty member brings to the project a Bachelor of Fine Arts in Design, a Master of Education in Elementary Education, and a PhD in Instructional Systems Technology. She also has K-12 teaching experience that includes elementary education, as well as middle and high school art and design education. Her expertise includes software design and development through the prior creation of an educational technology software. The third member of the design team, who joined the project in fall 2023, is a high school science and engineering teacher and doctoral student. She has 18 years of classroom experience teaching high school physics, engineering, and research, and has worked as a research engineer at a national laboratory on biomedical engineering projects. The team member has a Bachelor of Science in Mechanical and Biomedical Engineering, a Master of Education in Secondary Science, and is earning her doctorate in Instructional Technology.

### Description of Context

The school environment where the design emerged was a K-5 elementary school in a large metro school district in the southeast. The student population was just over 700, with close to 30% of students eligible for free and reduced lunch and close to 16% of students receiving special education services. Post-pandemic state mandated test scores, as well as school readiness scores, had both dropped 12% and 9% respectively, as compared to pre-pandemic measures. Students have music classes between four and five times a month for 45 minutes at a time. Multiple classes have music at the same time in combinations of general education classes and special education classes, meaning that class numbers can be upwards of 35-40 students at a time with limited paraprofessional support for classes with higher numbers of students with special needs. The music room has five electric piano keyboards that can “split” for two students to play at the same time with headphones hearing only themselves, meaning that ten students can access the pianos at a time. There is also an iPad cart that has 25 operational older generation devices that connect to the school Wi-Fi. On the iPads are a variety of educational apps that the district provides, including a digital piano keyboard that has colors. In addition, there is an interactive touch screen board that connects to the teacher laptop. In terms of relevant stakeholders, the administration at the school respects the autonomy of the music teacher/design lead to adapt her instruction to her learners' needs.

### Design Processes

Underpinning the design process for aspects of the present disclosure may place emphasis on learner experience design (LXD). LXD includes the tenets of (1) a human centric approach with the learner at the center of the design process, (2) an emphasis on the process of interaction and engagement, (3) a reliance on technology to enhance the overall experience, and (4) a design process that encompasses iterative feedback, evaluation, and improvements (Hickey & Correia, 2024). Additionally, user experience design methods complemented the LDX process. Schmidt and Huang (2021) noted that user experience design should be (a) human-centric, (b) theoretically grounded, and (c) socio-culturally sensitive, with the aim of supporting learners in achieving their individual learning goals (p. 152).

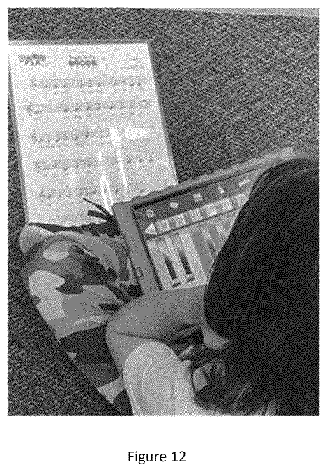

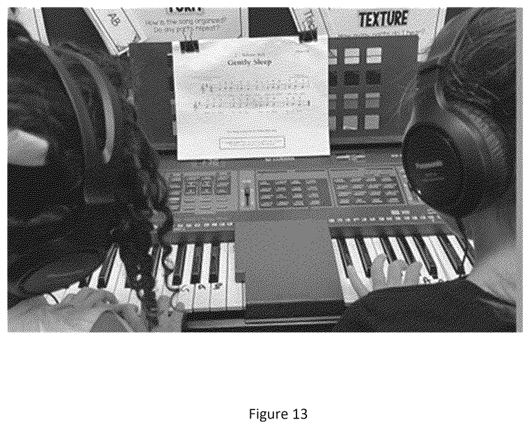

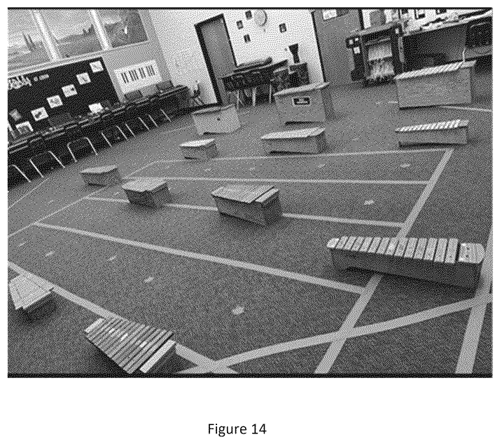

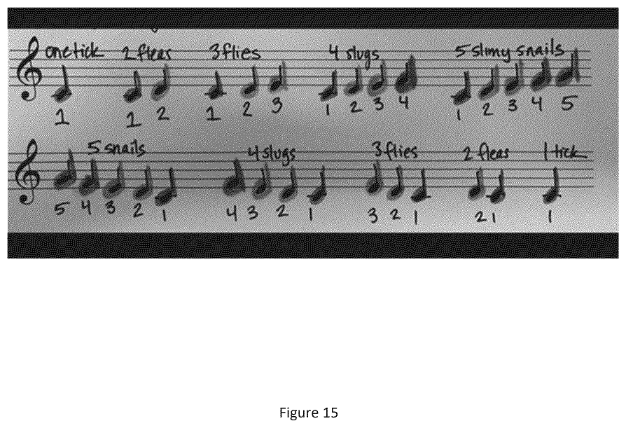

In terms of the design process that resulted in the creation of the initial prototype, the design lead developed paper-based iteration in the fall of 2021 to help students independently play melodies on the piano keyboard (see FIG. 9). The paper prototype was made by hand coloring song sheets to match the piano keyboard app Piano Infinity (Better Day Wireless Inc., 2023) that the district made available on classroom iPads (see FIG. 12). Prior to the color-coding system, students would draw letters on the keyboards with dry erase markers to help locate correct pitches (see FIG. 13). Sheet music was also labeled with letters, creating extra decoding and processing steps for students learning to read and play music. After the introduction of colors, the classroom teacher and design lead also began to color-code all the instruments and materials in the classroom for accessibility purposes (see FIGS. 14 and 15). Students were better able to process verbal directions when given with reference to colors, (e.g., “play a steady beat on red” rather than “play a steady beat on C”). Visual representations of melodies with color overlays were noticeably more accessible to students in a whole group setting.

During the revision and leveling phase, songs were organized according to the level of skill required to play. It is important to note the difficulty of the music reading process, as that informed how songs were arranged and presented. Music notes on the five-line staff require students to locate which line or space the note is on, decode the pitch name and duration of sound, and decode any editorial markings (e.g., staccato, legato) that inform how the note is to be played. The available visual input must be integrated and processed so the student can audiate, or hear in their head, what sounds the notes represent, like reading written language (Jaarsma et al., 1998, p. 138). Approaching the context with the lens of design judgment (see Nelson & Stolterman, 2012), the design lead altered the visual presentation of music notation guided by Universal Design for Learning (UDL) principles, which include reducing barriers to decoding symbols (CAST, 2018). Another design judgment involved the addition of color overlays to music notation, which supports decoding of the notes on the staff. In turn, the color overlays make it easier for students to discern the correct pitch to play on an instrument. Additionally, the color overlays allow for the design to be implemented universally as color can transcend linguistic and cultural barriers.

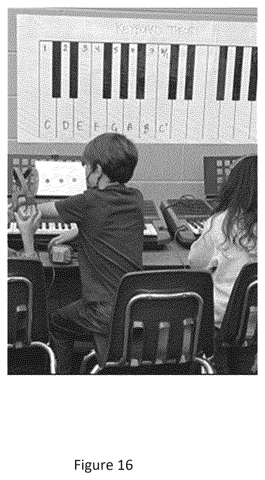

Implementation of the paper prototype version of present systems, methods, and kits also led to an iterative design approach in terms of the text/icon density and icon size. Some students showed a preference for larger music icons with color overlays, or just colors themselves to indicate pitch, equaling fewer visual processing demands (see FIG. 16). As the library of present disclosure grew, the management of materials became increasingly difficult, indicating the need for an accessible digital solution.

The design approach with the initial digital iteration was intentionally minimalist to not overburden visual processing and attention demands. The primary goal was to avoid split attention, or what occurs when attention is divided between multiple sources of visual input that need to be integrated together rather than processed in isolation (Sweller, 2019, pp. 8-10). For this purpose, a design judgment was made to avoid song lyrics with the songs and written directions on those pages unless necessary. Song representations also do not include letters as labels for music notes as it adds to the cognitive processing demands with additional decoding. Other related design judgments included omitting the animation of objects or characters on the screen until the effectiveness of the minimalist version could be determined. The simplified visual presentation lends the tool greater flexibility in application. Given that the goal of the preliminary digital interface was to remove barriers to reading music as well as increasing student play and engagement, the design judgement was made to omit assessment as part of the tool. In this way, the focus of the tool and its implementation are play and process.

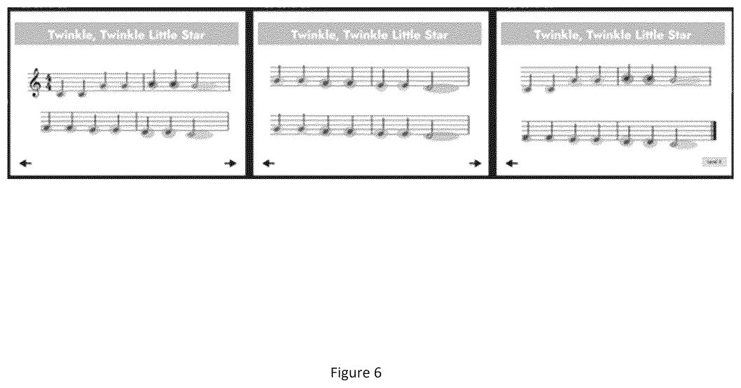

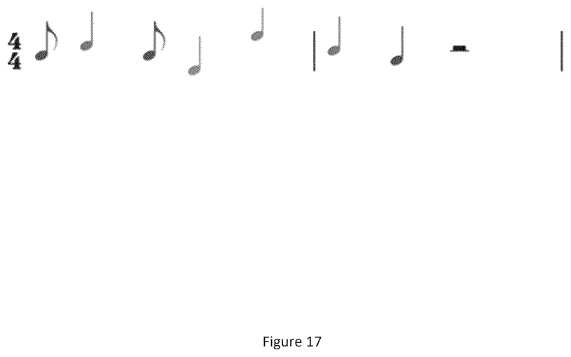

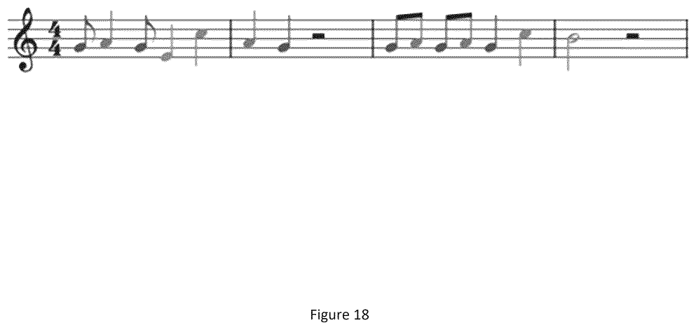

Preliminary digital prototype development began in the fall of 2022. Originally, the design lead translated the paper prototype to Google Jamboard; however, it did not offer the desired design tools or presentation options. When the design team expanded to two teacher scholars, the design lead was encouraged to pivot to Figma in spring 2023 due to its low cost for educators and high level of functionality for wire frame development. Additionally, music notation was first arranged using Noteflight (Noteflight LLC, 2023), a music composition software, and then imported into Figma. Noteflight has the option of using music icons in different colors, but the lack of visual contrast on the white background for certain colors proved difficult for visual recognition and processing (see FIGS. 17 and 18). The design lead determined that the note icons should be in black and pitch colors should be semi-transparent overlays in the shapes of circles that can be shortened or elongated to indicate duration, or length of sound (see FIGS. 6 and 10). The circular shape of the overlays was intentional as it mirrors the shape of the note head on the traditional icon. The semi-transparency of the overlay allows the learner to see the note icons in proper staff placement, potentially casing the transition to reading music without the overlays, making the notation easier to read.

Within the digital prototype, each song in the library is viewable with distinct levels of visual supports that flow into one another. This design judgment enables a student to choose a level of visual support that fits their learning needs. If they choose level one (see FIG. 7), it will take them to a song presentation of only short or long circles of color in relative position to how high or low the pitch is. At the end of level one, the song will transition to level two (see FIG. 10), and then level three (see FIG. 11), unless the student chooses to return to the beginning or the main menu. Level two is the presentation of the song with notes on the staff and color overlays, whereas level three is the standard presentation with no color supports. The ability for the student to choose where to start enables fluid transition between levels and supports learner autonomy. Student control of the learning process is an essential part of self-regulated learning, as it supports proactive learning and helps students develop higher self-satisfaction and motivation (Zimmerman, 2004, pp. 145-146). McPherson and Renwick (2001, 2002) found a positive relationship between intrinsic motivation and faster musical progress, as well as student choice and stronger performances (as cited by Varela et al., 2016, p. 57). Giving students song choice and adjustable levels of support increases potential success and motivation to play more music.

Initial student testing of the digital prototype during spring and summer 2023 with upper elementary students showed the need to transition from using buttons to move between pages of music to more of a “flip” of the page. During initial testing, the design lead also solicited feedback from two other music teachers, who recommended embedding sound within the color overlays to allow students to hear the song and self-assess their progress. This idea supported student development of audiation skills. Additional ideas for improving functionality included the ability to “swipe” pages horizontally to progress through the song one level at a time with the option of a vertical “swipe” to access different song levels without having to transition back to the song menu page to select a different level. The design feature offers students the ability to easily adjust to the level that they need with minimal difficulty, thereby limiting frustration.

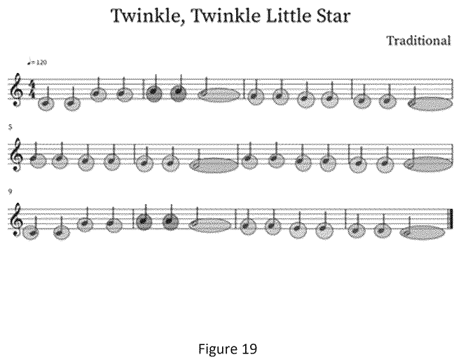

Additional applications of the present tool were discovered that go beyond individual student study. By presenting the whole of a song in standard notation with color overlays, students were guided towards recognizing more advanced musical concepts such as form, or how the song is organized, as well as tonality, or what key a song is in. For example, using color overlays for Twinkle, Twinkle Little Star (see FIG. 19), students were able to recognize that there are several parts of the melodic line that repeat by observing the color patterns. By noticing patterns and repetition, students were able to “chunk” musical phrases and master the song more quickly (Kauffman & Carlsen, 1989, p. 11). Chunking of musical phrases also allowed students to recognize the form of the song.

Concerning tonality, the color scaffolds allowed students to recognize that the same song itself (see FIG. 19) begins and ends on the same color, helping to establish that the song's tonal center is red, or C, putting the song in the key of C major. There is potential to take this journey into tonality even further using color scaffolds. Teachers could use the middle line that features blue (G) and orange (D), as a bridge to helping students discover that the song shifts from tonic (tonal center on C, the first scale degree in the key of C major) to the dominant (tonal center on G, or the fifth scale degree in the key of C major), which would allow for the creation of chords and harmonies to be played in the left hand. Within a whole group setting, this would allow for students to build multi-part music featuring the melody and a harmonic accompaniment.

Simply having access to simplified notation and color scaffolding would allow students to make deeper connections and extend into higher levels of thinking that the cognitive load of the original standard notation would impede. In this same way, using colors to compose melodies would allow students to make connections between tonalities and the pitches/colors they choose to compose with. For example, students composing melodies could begin to make connections between different tonal centers, or keys, and major, minor, and modal tonalities. Better understanding the qualities of these different tonalities would allow them to make connections between moods or feelings and the music they compose (e.g., minor keys for “sad” songs and major keys for “happy” songs).

### Admin Dashboard

In an aspect, the systems and methods described herein may be executed on an application. Such an application may comprise an administrative (admin) dashboard. The admin dashboard may allow an instructor (e.g., teacher, etc.) to control settings (e.g., configurations, etc.) associated with one or more instances of the application accessed by students associated with the instructor. For example, the admin dashboard may allow the instructor to request, add, and/or remove songs and/or categories of songs accessible to the students associated with the instructor. As a further example, an instructor at a religious school may wish for associated students to have access to hymnals; however, access to the hymnals may be deemed inappropriate by an instructor at a public school for associated students, wherein the instructor wishes to maintain a separation of church and state.

The admin dashboard may allow an instructor to control a look and feel of associated one or more instances of the application. For example, although some figures included in this disclosure, such as FIGS. 1-4, for example, show a single measure of music notation, the admin dashboard may allow an instructor to change a view associated with the one or more associated instances of the application such that multiple measures of music notation may be displayed on a single screen, vertically. The application may work from a top measure of music notation downwards to a bottom measure of music notation. As sheet music has multiple measures of music notation on a single sheet, the option allowing the instructor to change the view to include multiple measures of music notation on a single screen may cause the view associated with the associated instance of the application to appear more like actual sheet music.

Another aspect of the look and feel of the one or more associated instances of the application that the admin dashboard may allow the instructor to manipulate (e.g. change, customize, etc.) comprises the color of the symbols to denote an aspect of the music. For example, the instructor may use the admin dashboard to change the colors so that colors on keys of a keyboard in a classroom associated with the instructor match colors shown in the one or more associated instances of the application. That is, the instructor may adjust associated settings of the one or more associated instances such that a key on a keyboard producing a particular pitch comprises a particular color, and a symbol indicating the particular pitch comprises the particular color.

Another aspect of the look and feel of the one or more associated instances of the application that the admin dashboard may allow the instructor to manipulate may comprise overlays. An overlay may comprise a letter corresponding to a note indicated by a symbol. An overlay may comprise adding indications of if a note is sharp, flat, etc. An overlay may include which hand (left or right) should be used to play a note corresponding to an associated symbol. An overlay may comprise lyrics associated with a song.

In an aspect, the admin dashboard may allow an instructor to manipulate (e.g., change, customize, etc.) an instance of the application associated with a particular student. For example, an instructor may determine that a student has mastered a particular note. The instructor may use the admin dashboard to cause the particular note be displayed without the symbol for an instance of the application associated with the student, while other symbols for other notes are displayed in the instance of the application.

### Kit

In an aspect, the systems and methods described herein may be embodied in a kit. The kit may comprise a plurality of stickers. Each of the plurality of stickers may comprise a symbol indicating an aspect of music, such as pitch and/or duration. A sticker may be placed on a component of a musical instrument corresponding to the aspect of music indicated by the symbol associated with the sticker. For example, a sticker with a symbol indicating an F note may be placed on a key of a keyboard, wherein the key is associated with an F note.

The kit may comprise a plurality of sheets. The sheets may be grouped by songs. Each group may have multiple versions. A first version of a group may comprise a representation of a song by the symbols, similar to a representation of music shown in FIG. 1. The symbols on the first version of the group may correspond to the symbols on the stickers. A second version of the group may comprise a representation of the song by the symbols overlayed on notes, similar to a representation of music shown in FIG. 2. A third version of the group may comprise a representation of the song by the symbols overlayed on the notes and positioned on a staff and a clef, similar to a representation of music shown in FIG. 3. A fourth version of the group may comprise a representation of the song by the notes positioned on a staff and a clef, without the symbols, similar to a representation of music shown in FIG. 4.

A student may master a song by progressing through a group associated with the song. The student may use a first sheet comprising a first version of the group of the song to match symbols on stickers of components of an instrument with symbols in the sheet. The student may then use a second sheet comprising a second version of the group of the song to match the symbols on the stickers of the components of the instrument with the symbols in the sheet, while observing associated notes. The student may then use a third sheet comprising a third version of the group of the song to match the symbols on the stickers of the components of the instrument with the symbols in the sheet, while observing associated notes on a staff and a clef. The student may then use a fourth sheet comprising a fourth version of the group of the song to play the song on the instrument by reading the notes on the staff and the clef as observed in previous steps.

### Future Development

Future phases of development will focus on integrating new features into song presentation, such as including the bass clef and choosing to “turn colors off” as they are mastered, integrating administration controls, expanding the song library, and developing a digital composition function. Including the bass clef will support students transitioning to two handed playing, which is essential for further piano study. The feature of taking colors away one color a time will be another layer of differentiation according to need. Students will be able to choose to only see the color overlays of the notes they have not yet mastered (e.g., “turning off” all red notes once they recognize the note pitch via placement on the staff). The composition function will include a variety of backgrounds and a composition toolbox for students and teachers to choose from, allowing teachers to differentiate instructional activities. Backgrounds will include the music staff, an abbreviated staff (two to three lines rather than the standard five), and empty bar lines for rhythm patterns, while the toolbox will include standard music icons and color circles that can change length to indicate duration as well as play the pitch indicated by color like Levels 1 and 2 in the song library. The color circles would also adjust to the appropriate pitch height in relation to one another to allow students the ability to explore the up and down directionality of the melodic line as they build their compositions. Future development will also prioritize accessible color palettes for learners with color-blindness (e.g., Protanopia-type, Deuteranopia-type) while Web Content Accessibility Guidelines (WCAG) accessibility standards.

There is a marketplace gap for the methods and systems described herein of a scaffolded support tool in music classroom contexts.

### Flowcharts for Example Methods of Teaching Music Notation

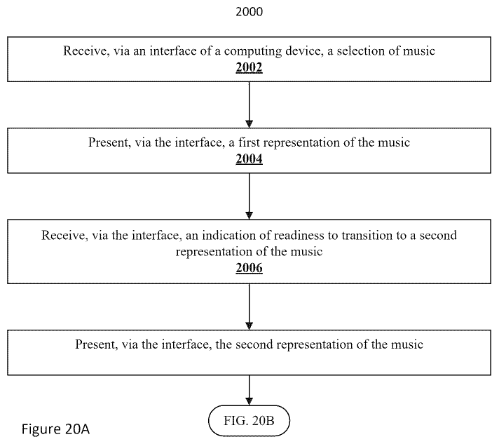

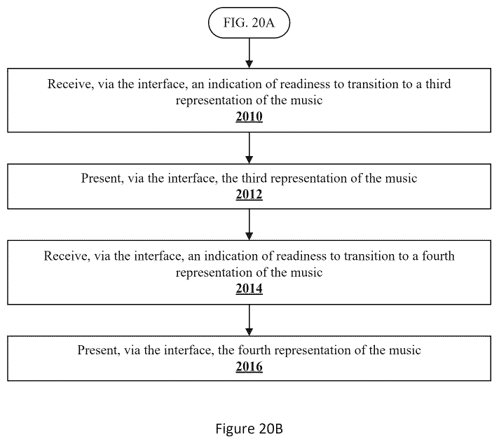

FIGS. 20A and 20B are a flowchart of an example process 2000. In some implementations, one or more process blocks of FIGS. 20A and 20B may be performed by a computing device.

As shown in FIG. 20A, process 2000 may include receiving, via an interface of a computing device, a selection of music (block 2002). For example, a computing device may receive, via an interface of the computing device, a selection of music, as described above. As also shown in FIG. 20A, process 2000 may include presenting, via the interface, a first representation of the music (block 2004). The first representation may include symbols. Each symbol may correspond to an aspect of the music. The aspect of the music may be at least one of pitch and duration, and the first representation of the music does not include clef, staff, or notes. For example, the computing device may present, via the interface, a first representation of the music, where the first representation may include symbols, where each symbol corresponds to an aspect of the music, where the aspect of the music is at least one of pitch and duration, and where the first representation of the music does not include clef, staff, or notes, as described above. As further shown in FIG. 20A, process 2000 may include receiving, via the interface, an indication of readiness to transition to a second representation of the music (block 2006). For example, the computing device may receive, via the interface, an indication of readiness to transition to a second representation of the music, as described above. As also shown in FIG. 20A, process 2000 may include presenting, via the interface, the second representation of the music (block 2008). The second representation of the music may include the symbols overlayed on notes, and the second representation of the music does not include clef or staff. For example, the computing device may present, via the interface, the second representation of the music, where the second representation of the music may include the symbols overlayed on notes, and where the second representation of the music does not include clef or staff, as described above. As further shown in FIG. 20B, process 2000 may include receiving, via the interface, an indication of readiness to transition to a third representation of the music (block 2010). For example, the computing device may receive, via the interface, an indication of readiness to transition to a third representation of the music, as described above. As also shown in FIG. 20B, process 2000 may include presenting, via the interface, the third representation of the music (block 2012). The third representation of the music may include the symbols overlayed on the notes and clef and staff. For example, the computing device may present, via the interface, the third representation of the music, where the third representation of the music may include the symbols overlayed on the notes and clef and staff, as described above. As further shown in FIG. 20B, process 2000 may include receiving, via the interface, an indication of readiness to transition to a fourth representation of the music (block 2014). For example, the computing device may receive, via the interface, an indication of readiness to transition to a fourth representation of the music, as described above. As also shown in FIG. 20B, process 2000 may include presenting, via the interface, the fourth representation of the music (block 2016). The fourth representation of the music may include the notes, clef, and staff, and the fourth representation of the music does not include the symbols For example, the computing device may present, via the interface, the fourth representation of the music, where the fourth representation of the music may include the notes, clef, and staff, and where the fourth representation of the music does not include the symbols, as described above.

Process 2000 may include additional implementations, such as any single implementation or any combination of implementations described below and/or in connection with one or more other processes described elsewhere herein. In a first implementation, each symbol corresponds to a component of an instrument configured to produce a pitch.

In a second implementation, alone or in combination with the first implementation, each symbol corresponds to a key on a keyboard or a tonal bar.

In a third implementation, alone or in combination with the first and second implementation, each symbol indicating a particular pitch may include a particular color or pattern and a corresponding key or tonal bar is associated with the particular pitch and may include the particular color or pattern.

In a fourth implementation, alone or in combination with one or more of the first through third implementations, one or more of a color, pattern, and vertical position of a particular symbol of the symbols indicates a pitch indicated by the particular symbol.

In a fifth implementation, alone or in combination with one or more of the first through fourth implementations, a size of a particular symbol of the symbols indicates a duration indicated by the particular symbol.

In a sixth implementation, alone or in combination with one or more of the first through fifth implementations, the staff is a pentagram.

In a seventh implementation, alone or in combination with one or more of the first through sixth implementations, the fourth representation of the music is a Western Standard Notation representation of the music.

An eighth implementation, alone or in combination with one or more of the first through seventh implementations, process 2000 further includes receiving, via the interface, an indication of readiness to transition to the third representation of the music; presenting, via the interface, the third representation of the music.

A ninth implementation, alone or in combination with one or more of the first through eighth implementations, process 2000 further includes receiving, via the interface, an indication of readiness to transition to the second representation of the music; presenting, via the interface, the second representation of the music.

A tenth implementation, alone or in combination with one or more of the first through ninth implementations, process 2000 further includes receiving, via the interface, an indication of readiness to transition to the first representation of the music; presenting, via the interface, the first representation of the music.

Although FIGS. 20A and 20B show example blocks of process 2000, in some implementations, process 2000 may include additional blocks, fewer blocks, different blocks, or differently arranged blocks than those depicted in FIGS. 20A and 20B. Additionally, or alternatively, two or more of the blocks of process 2000 may be performed in parallel.

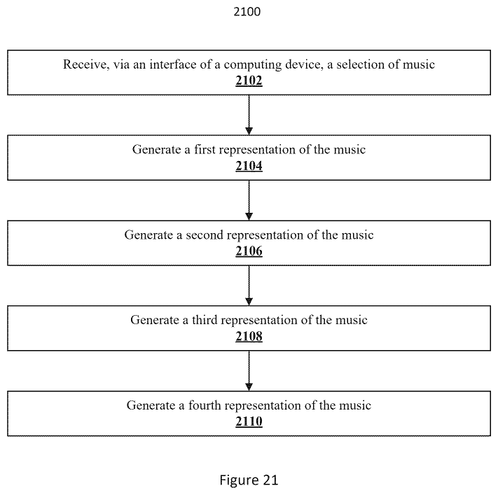

FIG. 21 is a flowchart of an example process 2100. In some implementations, one or more process blocks of FIG. 21 may be performed by a computing device.

As shown in FIG. 21, process 2100 may include receiving, via an interface of a computing device, a selection of music (block 2102). For example, a computing device may receive, via an interface of the computing device, a selection of music, as described above. As also shown in FIG. 21, process 2100 may include generating a first representation of the music (block 2104). The first representation may include symbols. Each symbol may correspond to an aspect of the music, and the aspect of the music may be at least one of pitch and duration. The first representation of the music does not include clef, staff, or notes. For example, the computing device may generate a first representation of the music, where the first representation may include symbols, where each symbol corresponds to an aspect of the music, where the aspect of the music is at least one of pitch and duration, and where the first representation of the music does not include clef, staff, or notes, as described above. As further shown in FIG. 21, process 2100 may include generating a second representation of the music (block 2106). The second representation of the music may include the symbols overlayed on notes, and the second representation of the music does not include clef or staff. For example, the computing device may generate a second representation of the music, where the second representation of the music may include the symbols overlayed on notes, and where the second representation of the music does not include clef or staff, as described above. As also shown in FIG. 21, process 2100 may include generating a third representation of the music (block 2108). The third representation of the music may include the symbols overlayed on the notes and clef and staff. For example, the computing device may generate a third representation of the music, where the third representation of the music may include the symbols overlayed on the notes and clef and staff, as described above. As further shown in FIG. 21, process 2100 may include generating a fourth representation of the music (block 2110). The fourth representation of the music may include the notes, clef, and staff, and the fourth representation of the music does not include the symbols. For example, the computing device may generate a fourth representation of the music, where the fourth representation of the music may include the notes, clef, and staff, and where the fourth representation of the music does not include the symbols, as described above.

Process 2100 may include additional implementations, such as any single implementation or any combination of implementations described below and/or in connection with one or more other processes described elsewhere herein. A first implementation, process 2100 further includes determining a determined representation of the music of the first representation of the music, the second representation of the music, the third representation of the music, and the fourth representation of the music; and presenting, via the interface, the determined representation of the music.

In a second implementation, alone or in combination with the first implementation, the determining the determined representation of the music is based on one or more of audio signals received during a session, user input signals indicative of instrument engagement received during a session, historical progress and historical regress.

Although FIG. 21 shows example blocks of process 2100, in some implementations, process 2100 may include additional blocks, fewer blocks, different blocks, or differently arranged blocks than those depicted in FIG. 21. Additionally, or alternatively, two or more of the blocks of process 2100 may be performed in parallel.

### Three-Stage Example

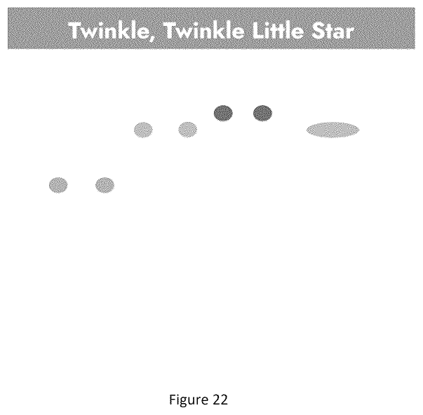

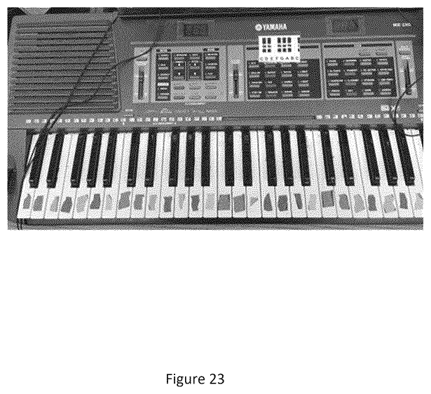

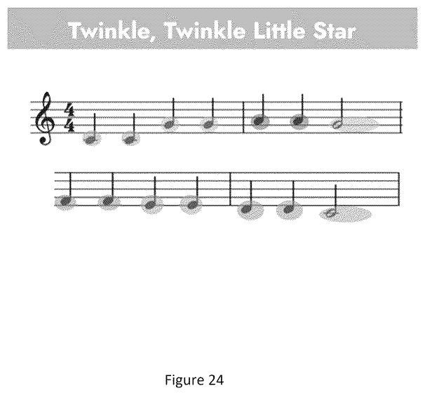

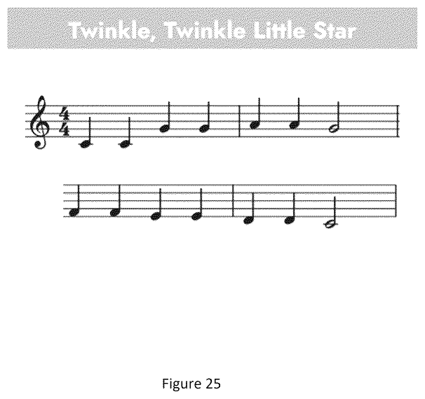

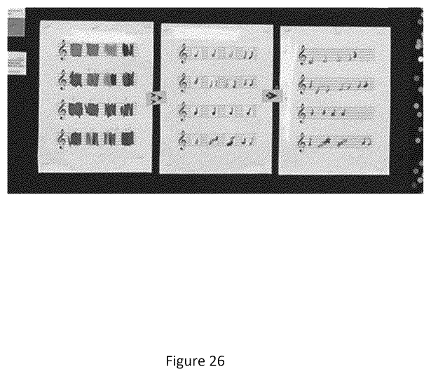

Turning to FIGS. 22-26, a three-stage example is shown. FIG. 22 shows an example representation of a portion of Twinkle, Twinkle Little Star with color-coded symbols. FIG. 23 shows an example keyboard with color-coded keys. Notes indicated by colors from the representation in FIG. 22 may match keys on the keyboard in FIG. 23. FIG. 24 shows an example representation of the portion of Twinkle, Twinkle Little Star with the color-coded symbols overlayed notes in traditional notation with staff and clef. FIG. 25 shows an example representation of the portion of Twinkle, Twinkle Little Star in traditional notation without the color-coded symbols. FIG. 26 shows an example system with sketched color melodies. In an aspect, a user may sketch a shape, such as a rectangle, wherein a color indicates a pitch and a width indicates a duration. In an aspect, a user may place notes of various colors and/or types on a blank staff, wherein the color and/or vertical placement may indicate pitch and the note type and/or horizontal placement may indicate a duration. In an aspect, a user may create notes of various colors on a blank staff, wherein the color and/or vertical placement may indicate pitch and the note type and/or horizontal placement may indicate a duration.

Learning to read traditional music notation is difficult for young learners and those with visual processing difficulties. Reading music is a multi-step process requiring the learner to decode the note/symbol to determine duration or how long to play the sound, locate where the symbol is on the lines and spaces of the staff to determine the pitch, then locate where on the instrument to play to match the desired pitch, and finally audiating, or hearing the sound in your head to see if it matches what you have played. It is a difficult and frustrating process for learners. Public school elementary music teachers benefit from this tool as they may be tasked with instructing 600-700 students for only 45 minutes in a given week and assessing students' ability to play an instrument. The purpose of the invention is to offer learning scaffolds to simplify the process and help students learn to play faster and more efficiently. At its most simplified/supported form, notes are replaced by colors (see FIG. 22) and matched to colors on the instrument (see FIG. 23). With a gradual release of supports, learners can progress to less supports with colors superimposed on traditional notation (see FIG. 24) with color-coded instruments, and finally to traditional notation (see FIG. 25).

The aspects of the present disclosure can be used to create or compose music in a similar manner. Learners can sketch/color melodies (see FIG. 26), assign duration values or rhythm and then place the notes on the staff according to the chosen color/pitch. The color process allows learners to first create by car and then progress to traditional notation.

### Four-Stage Example

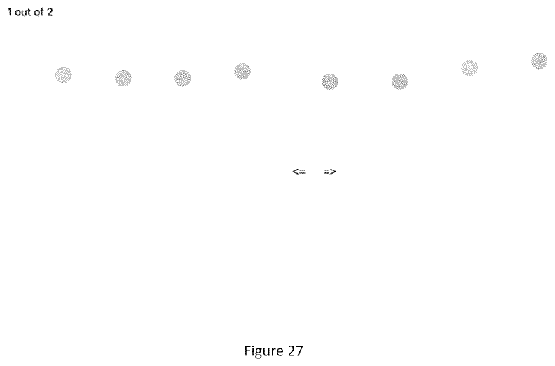

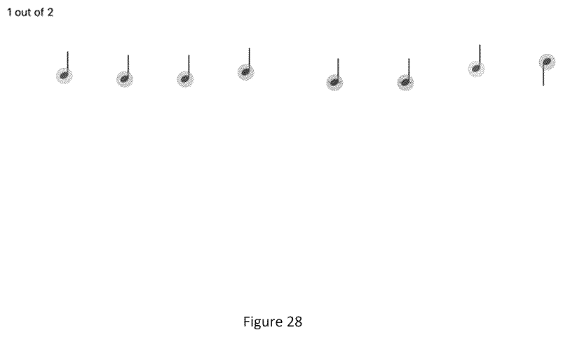

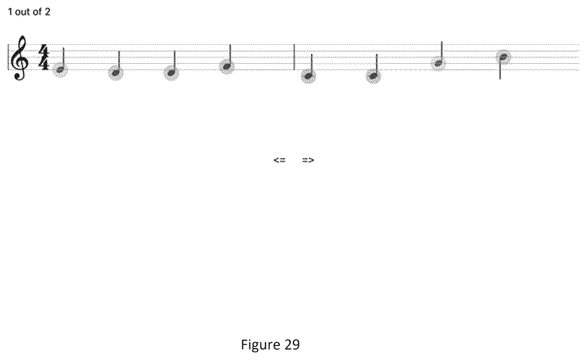

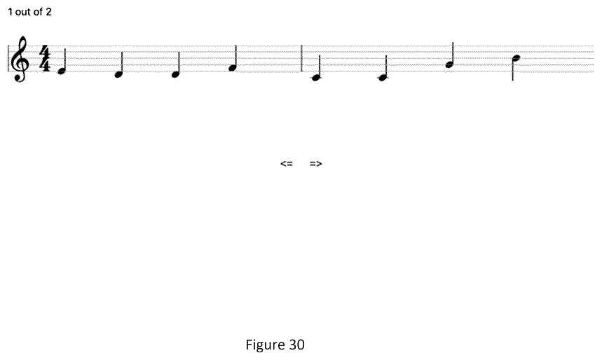

Turning to FIGS. 27-30, a four-stage example is shown. FIG. 27 shows an example representation of music with color-coded symbols. FIG. 28 shows an example representation of the music with the color-coded symbols overlayed notes. FIG. 29 shows an example representation of the music with the color-coded symbols overlayed notes in traditional notation with staff and clef. FIG. 30 shows an example representation of the music in traditional notation without the color-coded symbols. The four-stage example may comprise a color-coded instrument like the one shown with respect to the three-stage example in FIG. 23.

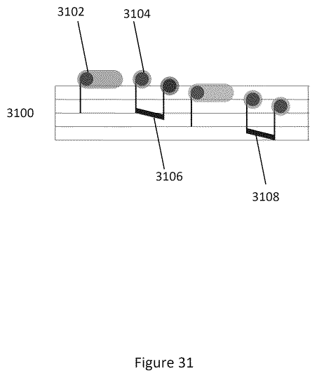

FIG. 31 shows an example display of music representation 3100 according to the systems and methods described herein. The music representation 3100 comprises a quarter note above a staff 3102. The music representation 3100 comprises an eighth note above the staff 3104. Although quarter notes and eighth notes are shown, any notes, such as whole notes, half notes, sixteenth notes, thirty-second notes, etc. may be used. The music representation 3100 may include a time signature, such as a 2/4 time signature, a ¾ time signature, a 4/4 time signature, a 6/8 time signature, etc. The time signature may be indicated on the music representation 3100. The music representation 3100 may comprise one or more beams to connect groups of eighth notes, such as beam 3106 or beam 3108.

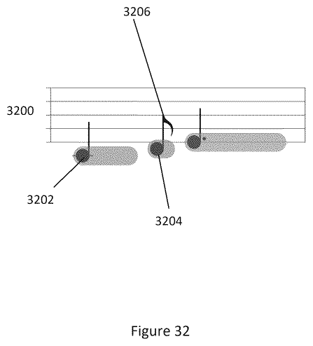

FIG. 32 shows an example display of music representation 3200 according to the systems and methods described herein. The music representation 3200 comprises a quarter note below a staff 3202. The music representation 3200 comprises an eighth note below the staff 3204. Although quarter notes and eighth notes are shown, any notes, such as whole notes, half notes, sixteenth notes, thirty-second notes, etc. may be used. The music representation 3200 may include a time signature, such as a 2/4 time signature, a ¾ time signature, a 4/4 time signature, a 6/8 time signature, etc. The time signature may be indicated on the music representation 3200. The music representation 3200 may comprise one or more flags to indicate eighth notes, such as beam 3206.

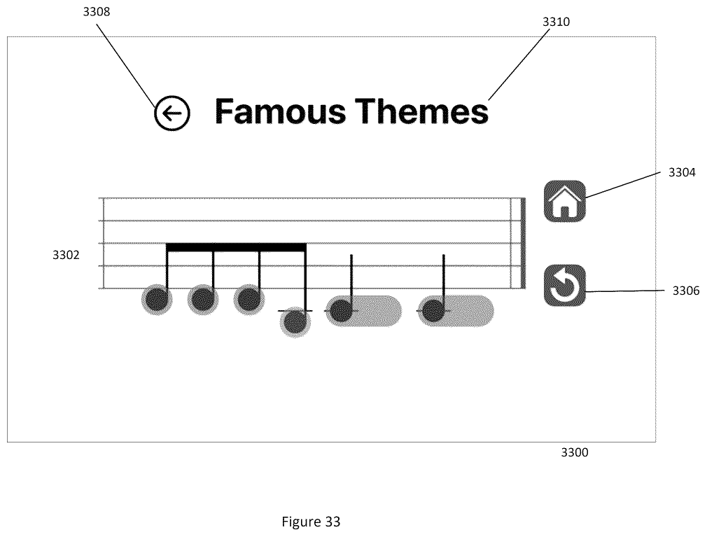

FIG. 33 shows an example graphical user interface (GUI) 3300 according to the systems and methods described herein. The GUI 3300 may comprise music representation section 3302 with notes on a staff as described above. The GUI 3300 may comprise a home button 3304. Engagement of the home button 3304 may cause an associated application to navigate to a home page. The GUI 3300 may comprise a restart button 3306. The restart button 3306 may cause the associated application to start at a beginning of a current song. The GUI may comprise a back button 3308. The back button 3308 may cause the associated application to return to a previous screen, such as song selection page, a home page, etc. The GUI 3300 may comprise a song title field 3310. The song title field 3310 may have a text representation of a song title associated with music represented in the music representation section 3302. The music representation section 3302 can comprise an indication of a sharp note (such as “///”) indicating that a user should play up a half step and/or indication of a flat note (such as “\\\” (indicating that a user should play down a half step.

The application may comprise a search and/or sort function. The search and/or sort function may allow songs to be searched and/or sorted by tone set and/or interval set. For example, the application may allow a user to search and/or sort by “so/mi” songs, “so/la/mi” songs, “so/la/mi/re/do” songs, “do/re/mi/fa/so/la/do” songs, songs that utilize a full 8-pitch scale, etc. Tone set options may comprise intervals that are developmentally appropriate for different ages and/or grade levels and/or correspond to national, state, and/or local music standards.

The search and/or sort function may also allow songs to be searched and/or sorted by rhythmic set. For example, the application may allow a user to search and/or sort by quarter notes only, quarters and eighth notes, half notes, whole notes, dotted notes, etc. Rhythm set options may comprise intervals that are developmentally appropriate for different ages and/or grade levels and/or correspond to national, state, and/or local music standards.

The application may comprise key change functionality. The key change functionality may, for example, change a song from F major to G major, or change the song from F major to F minor.

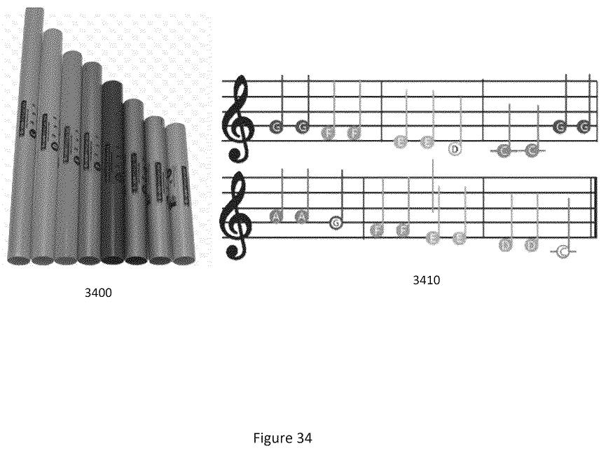

The application may allow a user to change colors associated with notes to match colors on an instrument. For example, FIG. 34 shows color coded instruments 3400 and an associated music representation 3410 with the correct associated coloring. Additionally, the application may comprise options to accommodate color-blindness. For example, instead of color, a pattern associated with each pitch may be used in place or in combination with notes. Additionally, the notes may be presented in gray scale.

The present disclosure comprises at least the following examples:

Example Clause A: A method for teaching music notation, the method may include: receiving, via an interface of a computing device, a selection of music; presenting, via the interface, a first representation of the music, where the first representation may include symbols, where each symbol corresponds to an aspect of the music, where the aspect of the music is at least one of pitch and duration, and where the first representation of the music does not include clef, staff, or notes; receiving, via the interface, an indication of readiness to transition to a second representation of the music; presenting, via the interface, the second representation of the music, where the second representation of the music may include the symbols overlayed on notes, and where the second representation of the music does not include clef or staff; receiving, via the interface, an indication of readiness to transition to a third representation of the music; presenting, via the interface, the third representation of the music, where the third representation of the music may include the symbols overlayed on the notes and clef and staff; receiving, via the interface, an indication of readiness to transition to a fourth representation of the music; and presenting, via the interface, the fourth representation of the music, where the fourth representation of the music may include the notes, clef, and staff, and where the fourth representation of the music does not include the symbols.

Example Clause B: The method of Example Clause A, where each symbol corresponds to a component of an instrument configured to produce a pitch.

Example Clause C: The method of Example Clause A or Example Clause B, where each symbol corresponds to a key on a keyboard or a tonal bar.

Example Clause D: The method of any one of Example Clauses A-C, where each symbol indicating a particular pitch may include a particular color or pattern and a corresponding key or tonal bar is associated with the particular pitch and may include the particular color or pattern.

Example Clause E: A computing device may include: one or more processors configured to perform the method of any of the of any one of Example Clauses A-D-11.

Example Clause F: The method of any one of Example Clauses A-E, where one or more of a color, pattern, and vertical position of a particular symbol of the symbols indicates a pitch indicated by the particular symbol.

Example Clause G: The method of any one of Example Clauses A-F, where a size of a particular symbol of the symbols indicates a duration indicated by the particular symbol.

Example Clause H: The method of any one of Example Clauses A-G, where the staff is a pentagram.

Example Clause I: The method of any one of Example Clauses A-H, where the fourth representation of the music is a Western Standard Notation representation of the music.

Example Clause J: The method of any one of Example Clauses A-I, further may include: receiving, via the interface, an indication of readiness to transition to the third representation of the music; presenting, via the interface, the third representation of the music.

Example Clause K: The method of any one of Example Clauses A-J, further may include: receiving, via the interface, an indication of readiness to transition to the second representation of the music; presenting, via the interface, the second representation of the music.

Example Clause L: The method of any one of Example Clauses A-K, further may include: receiving, via the interface, an indication of readiness to transition to the first representation of the music; presenting, via the interface, the first representation of the music.

Example Clause M: A system for teaching music reading may include: a musical instrument may include components configured to produce a pitch, where at least two of the components of the musical instrument may include an attribute, and where each attribute indicates a pitch associated with the component; and a computing device configured to: receive, via an interface, a selection of music; present, via the interface, a first representation of the music, where the first representation may include symbols, where each symbol corresponds to an aspect of the music, where the aspect of the music is at least one of pitch and duration, and where the first representation of the music does not include clef, staff, or notes; receive, via the interface, an indication of readiness to transition to a second representation of the music; present, via the interface, the second representation of the music, where the second representation of the music may include the symbols overlayed on notes, and where the second representation of the music does not include clef or staff; receive, via the interface, an indication of readiness to transition to a third representation of the music; present, via the interface, the third representation of the music, where the third representation of the music may include the symbols overlayed on the notes and clef and staff; receive, via the interface, an indication of readiness to transition to a fourth representation of the music; and present, via the interface, the fourth representation of the music, where the fourth representation of the music may include the notes, clef, and staff, and where the fourth representation of the music does not include the symbols.

Example Clause N: The system of Example Clause M, where the musical instrument is an instrument with a keyboard or tonal bars and the at least two components are at least two keys of the keyboard or tonal bars.

Example Clause O: The system of Example Clause M or Example Clause N, where the attribute may include a color or pattern.

Example Clause P: The system of any one of Example Clauses M-O, where a vertical position of a particular symbol of the symbols indicates a pitch of the particular symbol.

Example Clause Q: The system of any one of Example Clauses M-P, where a size of a particular symbol of the symbols indicates a duration a corresponding component of the musical instrument indicated by the particular symbol should be engaged.

Example Clause R: The system of any one of Example Clauses M-Q, where the staff is a pentagram.

Example Clause S: The system of any one of Example Clauses M-R, where the fourth representation of the music is a Western Standard Notation representation of the music.

Example Clause T: The system of any one of Example Clauses M-S, where the computing device is further configured to: receive, via the interface, an indication of readiness to transition to the third representation of the music; present, via the interface, the third representation of the music.

Example Clause U: The system of any one of Example Clauses M-T, where the computing device is further configured to: receive, via the interface, an indication of readiness to transition to the second representation of the music; present, via the interface, the second representation of the music.

Example Clause V: The system of any one of Example Clauses M-U, where the computing device is further configured to: receive, via the interface, an indication of readiness to transition to the first representation of the music; present, via the interface, the first representation of the music.

Example Clause W: The system of any one of Example Clauses M-V, where the musical instrument is a virtual musical instrument on a computing device.

Example Clause X: The system of any one of Example Clauses M-W, where the components of the musical instrument are virtual keys of a virtual keyboard displayed on a touch screen.

Example Clause Y: The system of any one of Example Clauses M-X, where the components of the musical instrument are virtual tonal bars of a virtual xylophone displayed on a touch screen.

Example Clause Z: A method for teaching music notation, the method may include: receiving, via an interface of a computing device, a selection of music; generating a first representation of the music, where the first representation may include symbols, where each symbol corresponds to an aspect of the music, where the aspect of the music is at least one of pitch and duration, and where the first representation of the music does not include clef, staff, or notes; generating a second representation of the music, where the second representation of the music may include the symbols overlayed on notes, and where the second representation of the music does not include clef or staff; generating a third representation of the music, where the third representation of the music may include the symbols overlayed on the notes and clef and staff; and generating a fourth representation of the music, where the fourth representation of the music may include the notes, clef, and staff, and where the fourth representation of the music does not include the symbols.

Example Clause AA: The method of Example Clause Z, further may include: determining a determined representation of the music of the first representation of the music, the second representation of the music, the third representation of the music, and the fourth representation of the music; and presenting, via the interface, the determined representation of the music.

Example Clause AB: A computing device may include: one or more processors configured to perform the method of any of Example Clause Z or Example Clause AA-27.

Example Clause AC: The method of 26, where the determining the determined representation of the music is based on one or more of audio signals received during a session, user input signals indicative of instrument engagement received during a session, historical progress and historical regress.

Example Clause AD: A computing device for teaching music notation may include: one or more processors configured to: receive, via an interface of a computing device, a selection of music; present, via the interface, a first representation of the music, where the first representation may include symbols, where each symbol corresponds to an aspect of the music, where the aspect of the music is at least one of pitch and duration, and where the first representation of the music does not include clef, staff, or notes; receive, via the interface, an indication of readiness to transition to a second representation of the music; present, via the interface, the second representation of the music, where the second representation of the music may include the symbols overlayed on notes, and where the second representation of the music does not include clef or staff; receive, via the interface, an indication of readiness to transition to a third representation of the music; present, via the interface, the third representation of the music, where the third representation of the music may include the symbols overlayed on the notes and clef and staff; receive, via the interface, an indication of readiness to transition to a fourth representation of the music; and present, via the interface, the fourth representation of the music, where the fourth representation of the music may include the notes, clef, and staff, and where the fourth representation of the music does not include the symbols.

Example Clause AE: The computing device of Example Clause AD, where each symbol corresponds to a component of an instrument configured to produce a pitch.

Example Clause AF: The computing device of Example Clause AD or Example Clause AE, where each symbol corresponds to a key on a keyboard or a tonal bar.

Example Clause AG: The computing device of any one of Example Clauses AD-AF, where the one or more processors, when each symbol indicating a particular pitch, are configured to a particular color or pattern and a corresponding key or tonal bar is associated with the particular pitch and may include.

Example Clause AH: The computing device of any one of Example Clauses AD-AG, where one or more of a color, pattern, and vertical position of a particular symbol of the symbols indicates a pitch indicated by the particular symbol.

Example Clause AI: The computing device of any one of Example Clauses AD-AH, where a size of a particular symbol of the symbols indicates a duration indicated by the particular symbol.

Example Clause AJ: The computing device of any one of Example Clauses AD-AI, where the staff is a pentagram.

Example Clause AK: The computing device of any one of Example Clauses AD-AJ, where the fourth representation of the music is a Western Standard Notation representation of the music.

Example Clause AL: The computing device of any one of Example Clauses AD-AK, where the one or more processors are further configured to: receive, via the interface, an indication of readiness to transition to the third representation of the music; and present, via the interface, the third representation of the music.

Example Clause AM: The computing device of any one of Example Clauses AD-AL, where the one or more processors are further configured to: receive, via the interface, an indication of readiness to transition to the second representation of the music; and present, via the interface, the second representation of the music.

Example Clause AN: The computing device of any one of Example Clauses AD-AM, where the one or more processors are further configured to: receive, via the interface, an indication of readiness to transition to the first representation of the music; and present, via the interface, the first representation of the music.

Example Clause AO: A computing device for teaching music notation may include: one or more processors configured to: receive, via an interface of a computing device, a selection of music; generate a first representation of the music, where the first representation may include symbols, where each symbol corresponds to an aspect of the music, where the aspect of the music is at least one of pitch and duration, and where the first representation of the music does not include clef, staff, or notes; generate a second representation of the music, where the second representation of the music may include the symbols overlayed on notes, and where the second representation of the music does not include clef or staff; generate a third representation of the music, where the third representation of the music may include the symbols overlayed on the notes and clef and staff; and generate a fourth representation of the music, where the fourth representation of the music may include the notes, clef, and staff, and where the fourth representation of the music does not include the symbols.

Example Clause AP: The computing device of Example Clause AO, where the one or more processors are further configured to: determine a determined representation of the music of the first representation of the music, the second representation of the music, the third representation of the music, and the fourth representation of the music; and present, via the interface, the determined representation of the music.

Example Clause AQ: A kit may include: a plurality of stickers, where each sticker may include a symbol indicating an aspect of music, where each sticker is configured to be coupled to a component of a musical instrument, and where a component of the musical instrument that a sticker is coupled to is associated with the aspect of music indicated by the symbol associated with the sticker; and a plurality of sheets may include representations of music, where a first sheet may include a first representation of the music may include symbols associated with the plurality of stickers, where a second sheet may include a second representation of the music may include the symbols overlayed on associated notes, where a third sheet may include a third representation of the music may include the symbols overlayed on associated notes, clef, and staff, and where a fourth sheet may include a fourth representation of the music, where the fourth representation of the music may include the notes, clef, and staff, and where the fourth representation of the music does not include the symbols.

Example Clause AR: The kit of Example Clause AQ, where each of the plurality of stickers is configured to be coupled with a key of a keyboard.

Example Clause AS: The kit of Example Clause AQ or Example Clause AR, where each of the plurality of stickers is configured to be coupled to an area of a recorder proximate to a hole.

Example Clause AT: The kit of any one of Example Clauses AQ-AS, where each of the plurality of stickers is configured to be coupled with a key of a musical instrument.

Example Clause AU: The kit of any one of Example Clauses AQ-AT, where each of the plurality of stickers is configured to be coupled to an area of a musical instrument proximate to a hole.

Example Clause AV: The kit of any one of Example Clauses AQ-AU, where each of the plurality of stickers is configured to be coupled to a tonal bar of a xylophone.

Example Clause AW: The kit of any one of Example Clauses AQ-AV, where each of the plurality of stickers is configured to be coupled to a tonal bar of a musical instrument.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method for teaching music notation, the method comprising:
receiving, via an interface of a computing device, a selection of music;
presenting, via the interface, a first representation of the music, wherein the first representation comprises symbols, wherein each symbol corresponds to an aspect of the music, wherein the aspect of the music is at least one of pitch and duration, and wherein the first representation of the music does not include clef, staff, or notes;
receiving, via the interface, an indication of readiness to transition to a second representation of the music;
presenting, via the interface, the second representation of the music, wherein the second representation of the music comprises the symbols overlayed on notes, and wherein the second representation of the music does not include clef or staff;
receiving, via the interface, an indication of readiness to transition to a third representation of the music;
presenting, via the interface, the third representation of the music, wherein the third representation of the music comprises the symbols overlayed on the notes and clef and staff;
receiving, via the interface, an indication of readiness to transition to a fourth representation of the music; and
presenting, via the interface, the fourth representation of the music, wherein the fourth representation of the music comprises the notes, clef, and staff, and wherein the fourth representation of the music does not include the symbols.

2. The method of claim 1, wherein each symbol corresponds to a component of an instrument configured to produce a pitch.

3. The method of claim 2, wherein each symbol corresponds to a key on a keyboard or a tonal bar.

4. The method of claim 3, wherein each symbol indicating a particular pitch comprises a particular color or pattern and a corresponding key or tonal bar is associated with the particular pitch and comprises the particular color or pattern.

5. The method of claim 1, wherein one or more of a color, pattern, and vertical position of a particular symbol of the symbols indicates a pitch indicated by the particular symbol.

6. The method of claim 5, wherein a size of a particular symbol of the symbols indicates a duration indicated by the particular symbol.

7. The method of claim 1, wherein the staff is a pentagram.

8. The method of claim 1, wherein the fourth representation of the music is a Western Standard Notation representation of the music.

9. The method of claim 1, further comprising:
receiving, via the interface, an indication of readiness to transition to the third representation of the music; and
presenting, via the interface, the third representation of the music.

10. The method of claim 1, further comprising:
receiving, via the interface, an indication of readiness to transition to the second representation of the music; and
presenting, via the interface, the second representation of the music.

11. The method of claim 1, further comprising:
receiving, via the interface, an indication of readiness to transition to the first representation of the music; and
presenting, via the interface, the first representation of the music.

12. A method for teaching music notation, the method comprising:
receiving, via an interface of a computing device, a selection of music;
generating a first representation of the music, wherein the first representation comprises symbols, wherein each symbol corresponds to an aspect of the music, wherein the aspect of the music is at least one of pitch and duration, and wherein the first representation of the music does not include clef, staff, or notes;
generating a second representation of the music, wherein the second representation of the music comprises the symbols overlayed on notes, and wherein the second representation of the music does not include clef or staff;
generating a third representation of the music, wherein the third representation of the music comprises the symbols overlayed on the notes and clef and staff; and
generating a fourth representation of the music, wherein the fourth representation of the music comprises the notes, clef, and staff, and wherein the fourth representation of the music does not include the symbols.

13. The method of claim 12, further comprising:
determining a determined representation of the music of the first representation of the music, the second representation of the music, the third representation of the music, and the fourth representation of the music; and
presenting, via the interface, the determined representation of the music.

14. The method claim of 12, wherein the determining the determined representation of the music is based on one or more of audio signals received during a session, user input signals indicative of instrument engagement received during a session, historical progress and historical regress.

15. A kit comprising:
a plurality of stickers, wherein each sticker comprises a symbol indicating an aspect of music, wherein each sticker is configured to be coupled to a component of a musical instrument, and wherein a component of the musical instrument that a sticker is coupled to is associated with the aspect of music indicated by the symbol associated with the sticker; and
a plurality of sheets comprising representations of music, wherein a first sheet comprises a first representation of the music comprising symbols associated with the plurality of stickers, wherein a second sheet comprises a second representation of the music comprising the symbols overlayed on associated notes, wherein a third sheet comprises a third representation of the music comprising the symbols overlayed on associated notes, clef, and staff, and wherein a fourth sheet comprises a fourth representation of the music, wherein the fourth representation of the music comprises the notes, clef, and staff, and wherein the fourth representation of the music does not include the symbols.

16. The kit of claim 15, wherein each of the plurality of stickers is configured to be coupled with a key of a keyboard.

17. The kit of claim 15, wherein each of the plurality of stickers is configured to be coupled to an area of a recorder proximate to a hole.

18. The kit of claim 15, wherein each of the plurality of stickers is configured to be coupled with a key of a musical instrument.

19. The kit of claim 15, wherein each of the plurality of stickers is configured to be coupled to an area of a musical instrument proximate to a hole.

20. The kit of claim 15, wherein each of the plurality of stickers is configured to be coupled to a tonal bar of a musical instrument.
